(19) United States
(12) Patent Application Publication
(10) Pub. No.: US 2026/0129402 A1
(43) Pub. Date: May 7, 2026

(54) METHOD AND SYSTEM FOR IDENTIFYING A FIGHT

(71) Applicant: MOTOROLA SOLUTIONS, INC., CHICAGO, IL (US)

(72) Inventor: FILIP NORYS, CHRZANOW (PL)

(21) Appl. No.: 18/940,085

(22) Filed: Nov. 7, 2024

(51) Int. Cl. H04W 4/02; G06V 20/52; G08B 21/02; H04L 67/12; H04W 4/029

(52) U.S. Cl. CPC H04W 4/023; G06V 20/53; G08B 21/02; H04L 67/12; H04W 4/029

(57) ABSTRACT

A method and system for detecting a fight are provided. The method includes detecting, via a processing and analytics engine associated with a security camera of a communication system, that a gathering of individuals is within a field of view (FOV) of the security camera, determining a presence of a plurality of cell phones associated with the gathering of individuals; monitoring position and changes in position of each cell phone of the plurality of cell phones associated with the gathering relative to a respective cell phone owner; comparing the position and change of position to predetermined cell phone positioning thresholds stored in a memory associated with the processing and analytics engine; identifying a fight incident in response to breaches of the predetermined cell phone positioning thresholds; and generating and sending an alert indicative of the fight incident to a security radio associated with the communication system.

### BACKGROUND

Violence and conflict have been on the rise in communities, and more particularly in schools. Systems which promote safer schools are of high interest and often include the use of security cameras. However, even with the use of security cameras, fight detection in a school environment can be challenging, as the presence of individuals located in the vicinity of the fight may hinder the camera's ability to identify a fight incident.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a communication system formed and operating in accordance with some embodiments.

FIG. 2A, 2B, 2C shows a few non-limiting examples of cell phone position, cell phone movement, and cell phone velocity detectable by the communication system of FIG. 1, in accordance with some embodiments.

FIG. 3 is a flowchart of a method for detecting a fight incident in accordance with some embodiments.

FIG. 4 provides an example workflow for generation of aggregated results for additional verification of a fight incident in accordance with some embodiments

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Detecting and responding to fight incidents quickly is crucial to preventing escalation of the fight and ensuring that authorities can address the situation as quickly as possible. Although security cameras may be in place, a fight may very quickly attract a large crowd of spectators, such as spectator students in a school environment. The large crowd of spectators surrounding the fight often blocks the field of view (FOV) of the security camera making it difficult to identify a fight incident within the crowd. As another example, a fight incident may occur outside of the FOV of the camera, while spectators to the fight remain at least partially within the FOV of the camera. As the crowd increases and/or moves around, the problem of identifying the fight is exacerbated.

An additional challenge is that not all gatherings of spectators, for example spectator students in a school, result from a fight incident. In a school environment, there may be other reasons for a crowd of spectators to gather, such as school sports activities, change of classrooms in crowded hallways to name a few. Current security systems do not adequately address these challenges. Improved fight detection is crucial in preventing the escalation of violence at an incident. Improved fight detection will facilitate the ability of authorities to address the fight incident as quickly as possible. Thus, there exists a need for an improved technical method, device, and system for detecting a fight.

In accordance with one example embodiments, a method of detecting a fight is provided by: detecting, via a processing and analytics engine associated with a security camera of a communication system, that a gathering of individuals is within a field of view (FOV) of the security camera; determining a presence of a plurality of cell phones associated with the gathering of individuals; monitoring position and changes in position of each cell phone of the plurality of cell phones associated with the gathering relative to a respective cell phone owner; comparing the position and change of position to predetermined cell phone positioning thresholds stored in a memory associated with the processing and analytics engine; identifying a fight incident in response to breaches of the predetermined cell phone positioning thresholds; and generating and sending an alert indicative of the fight incident to a security radio associated with the communication system.

In accordance with another example embodiment, a communication system is provided, the communication system comprising a security camera; a processor operatively coupled to the security camera; an analytics engine operatively coupled to the processor; a memory operatively coupled to the processor and analytics engine, the processor and analytics engine being configured to: receive image inputs from the security camera; detect, within the received image inputs, a gathering of individuals within a field of view (FOV) of the security camera; determine a presence of a plurality of cell phones associated with the gathering of individuals; monitor position and changes in position of each cell phone relative to a respective cell phone owner; compare the position and change of position to predetermined cell phone positioning thresholds stored in a memory associated with the processing and analytics engine; identify a fight incident in response to breaches of the predetermined cell phone positioning thresholds; and generate and send an alert indicative of the fight incident to a security radio associated with the communication system.

Each of the above-mentioned embodiments will be discussed in more detail below, starting with example system and device architectures of the system in which the embodiments may be practiced, followed by an illustration of processing blocks for achieving an improved technical method, device, and system for detecting a fight.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

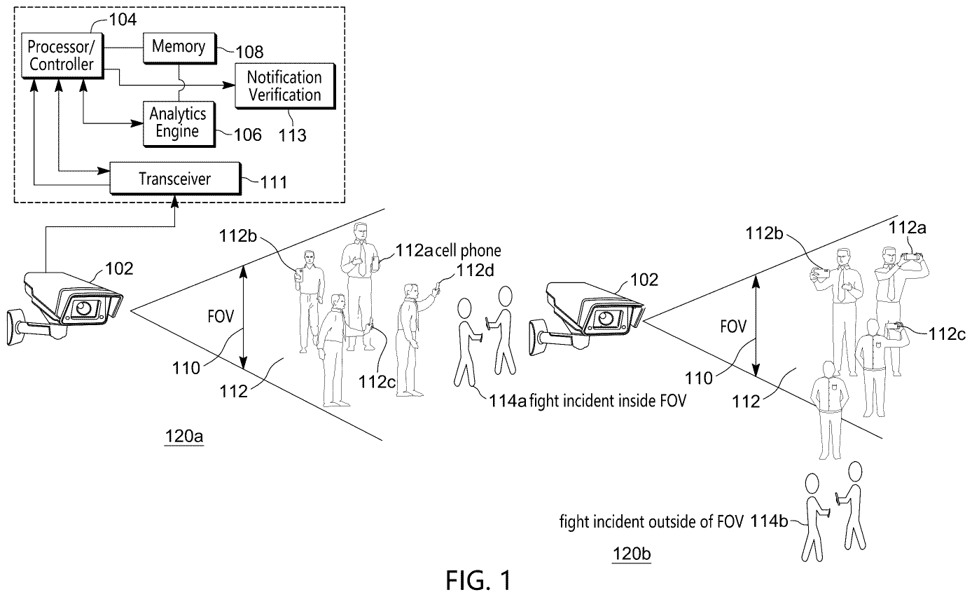

Referring now to the drawings, and in particular FIG. 1, there is shown a block diagram of a communication system 100 formed and operating in accordance with some embodiments. Communication system 100 comprises a security camera 102 having a processor 104, an analytics engine 106, and a memory 108 associated therewith. Communication system 100 further comprises a transceiver 111 and notification and verification block 113. The security camera 102 has a field of view (FOV) 110 associated therewith. The processor 104, analytics engine 106, and memory 108 may be located within the security camera 102 or operate as part of a cloud based server. The communication system 100 provides fight detection capability, such as in a hallway of a building, where a gathering of individuals or different groupings of individuals block the field of view (FOV) of the security camera 102. Communication system 100 is particularly advantageous to hallway applications, where the hallway is associated with a predicted human traffic flow, such as a school hallway where students change classrooms based on a predetermined classroom schedule.

The processor 104 and analytics engine 106 are configured to receive images from the security camera 102 and use the images to detect a gathering of individuals located within the FOV of the security camera 102. For example, detection based approach like people counting systems, distance between people estimation systems and/or deep learning density estimation systems, are processes, known in the art, which may be used to detect a gathering of individuals 112 within the FOV 110 of the security camera 102. An example of a gathering of individuals is shown in view 120a and in view 120b, wherein the gathering of individuals 112 are shown to be within (or at least partially within) the FOV 110 of security camera 102.

In view 120a, the gathering of individuals 112 blocks the FOV 110 of security camera 102, thereby blocking detection of a fight incident 114a taking place within the FOV 110 of camera 102. In view 120b, the gathering of individuals 112 are shown again as being within (or at least partially within) the FOV 110 of security camera 102, while a fight incident 114b is outside the FOV 110 of the security camera 102.

In accordance with some embodiments, images from the security camera 102 are transmitted (wired or wirelessly) to be received as input to the processor 104 and analytics engine 106 to determine a fight incident, even when the fight incident is not visible within the FOV 110 of camera 102 Briefly, and accordance with some embodiments, the communication system 100 identifies a fight incident based on the presence of cell phones within the FOV110 of the security camera 102, position and changes in position of each cell phone within the FOV, and a comparison of the position and change of position to predetermined cell phone positioning thresholds stored in the memory 108 associated with the communication system 100, as will be described.

In accordance with some embodiments, the processor 104 and analytics engine 106 are configured to determine the presence of a plurality of cell phones, such as illustrated by cell phones 112a, 112b, 112c, 112d associated with the gathering of individuals 112. For example, cell phone 112a and cell phone 112b may be visible within the FOV 110, while the position of cell phone 112c may be blocked by the owner's body, and therefore not currently detectable within the FOV 110. Cell phone 112d may be visible in the space above a user's head, but the actual owner may not be visible due to being blocked by the owners of cell phones 112a, 112b, 112c. When there is no incident, the detection of people and cell phones will be high. However, during a fight incident, people have a tendency to form rows, which results in obstructing some individuals thereby making people detection more difficult. As people maneuver their phones (e.g. raised up into a clear space overhead) to obtain a clear view of the incident, the cell phones become detectable.

In some embodiments, for example, the processor and analytics engine may further be configured to determine: a total number of individuals at the gathering within the FOV, a total number of individuals at the gathering holding a cell phone within the FOV, a percentage of cell phone owners at the gathering; and the percentage of cell phone owners compared to a predetermined cell phone user threshold stored in memory 108. The predetermined cell phone user threshold is a threshold that has been based on the system's ability to gather data from a sufficient number of cell phones within the FOV.

In accordance with some embodiments, the processor 104 and analytic engine 106 are further configured to monitor position and changes in position of the cell phones present within the FOV 110. The position and changes in position may be monitored via a plurality of parameter measurements associated with the cell phone. For example, the processor and analytics engine may be configured to monitor position and changes in position of each cell phone relative to a respective cell phone owner. The processor and analytics engine may further be configured to monitor velocity of the cell phone movement over time, and position of the cell phone relative to a cell phone owner's head. The processing and analytic engine may further be configured to monitor changes in position of cell phones as the gathering grows and/or shrinks. Such processing may comprise techniques of image recognition such as but not limited to people recognition, object recognition, object tracking, and motion analysis to determine the detections of people, cell phones, cell phones owners, further determining their locations, movements, and positional changes. Measurement results may vary over time as the position and change in position are dynamic.

The processor 104 and analytics engine 106 are further configured to compare the position and change of position to predetermined cell phone positioning thresholds, wherein such thresholds are stored in the memory 108 associated with the processor 104 and analytics engine 106. The processor 104 and analytics engine 106 then identify a fight incident in response to breaches of the predetermined cell phone positioning thresholds. For example changes in number of cell phones positioned above cell phone owners' heads exceeding a predetermined threshold, and changes in a ratio of number of cell phone owners vs number of cell phone owners having their cell phone above the head position. Due to the dynamic nature of an incident, static and/or dynamic thresholds may be applied.

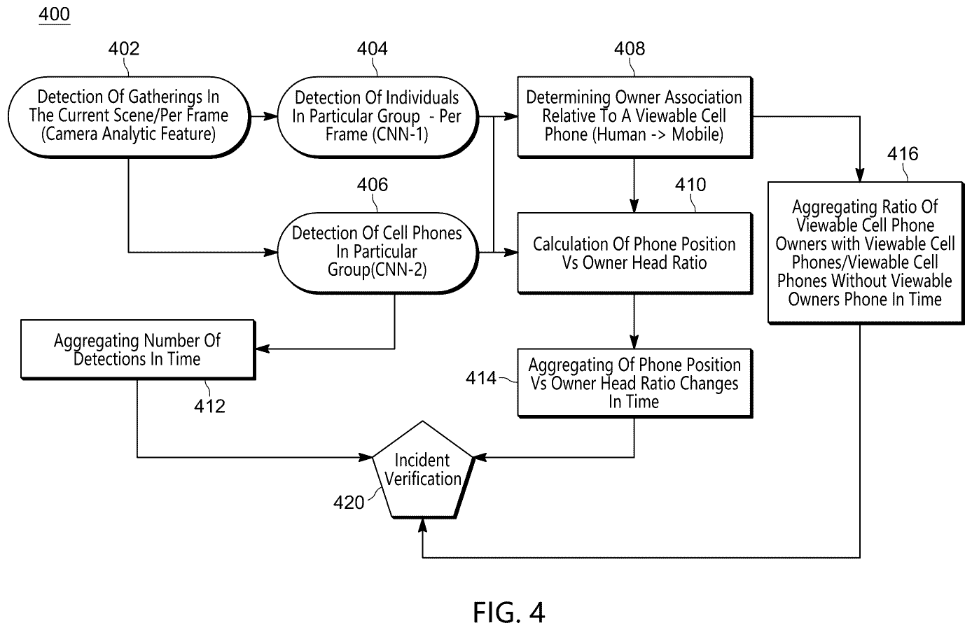

Additionally, in some embodiments several parameter measurements may be taken for each cell phone and cell phone owner and then aggregated for the gathering. For example, an aggregation of: total person count within the FOV, number of cell phones within the FOV, and number of cell phone owners within the FOV. The number of cell phones within the FOV and the number of cell phone owners within the FOV may not be the same. For example, when there is no incident, a ratio between detected cell phones and associated owners will be high due to the better visibly of people and cell phones during a non-incident. However, during a fight incident, where people have a tendency to form rows, which results in obstructing some individuals making people detection more difficult, As people maneuver their phones (e.g. raised up into a clear space overhead) to obtain a clear view of the incident, the cell phones become detectable, thereby lowering a ratio of detected phone versus/phone owner coefficient. Velocity of movement is another measurable parameter which may be incorporated into the detection. For example, the velocity of movement of the gathering of individuals moving into the FOV (high movement inward during peak of a fight), velocity of cell phones moving from a face/head position to an overhead position, velocity of cell phone movement from a face/head position to an above the head position. Aggregation examples are described in conjunction with FIG. 4

Analytical processing techniques for the parameter measurements may include, but are not limited to, image recognition such as but not limited to people recognition, facial recognition, object recognition, object tracking, and motion analysis to determine the detections of people, cell phones, cell phones owners, further determining their locations, movements, positional changes.

The processor is further configured to generate and send an alert indicative of the current detected fight incident to one or more security radios. The alert is transmitted from transceiver 111 to one or more security personnel communication devices, such as radio, cell phone or other security personnel device. For example, the alert may be transmitted over LTE, LMR (VHF, 700/800, UHF) to name a few. The communication system may further monitor for trends, which will be described later.

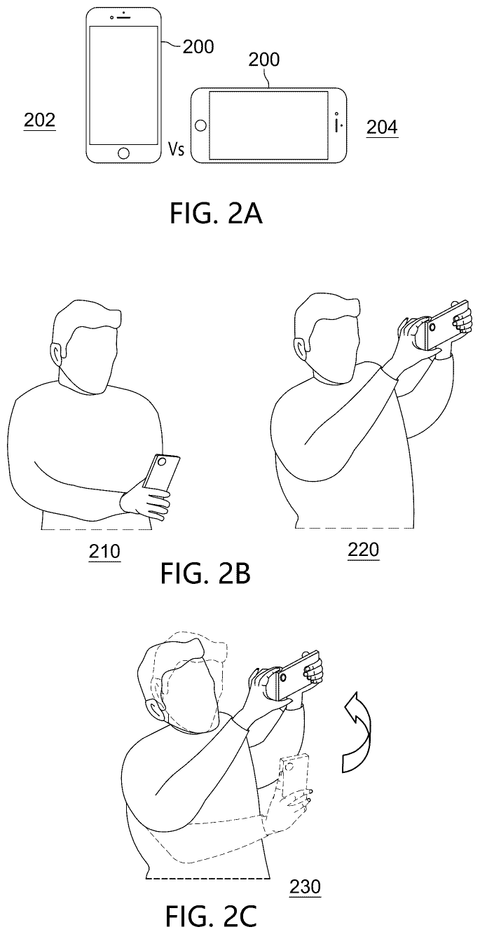

Referring briefly to FIGS. 2A, 2B, 2C, there are shown a variety of non-limiting examples of cell phone positions and changes in position which may be monitored in accordance with some embodiments. These positions and changes in positions are detectable within the FOV 110 of FIG. 1 as previously described An example of change in cell phone position is shown at FIG. 2A, where the change in positon of cell phone 200 shows a change from vertical orientation 202 to-horizontal orientation at 204 or vertical-to-horizontal as a measurable parameter. While the orientation of the cell phone 200 may be a useful measurable parameter, it is not necessarily required for the detection of a fight incident.

Position and change in position of cell phone movement relative to an owner's face (or head) is an example of another measurable parameter shown at 220. For example, holding a titled cell phone away from an owner's face (or head—as the owner's face may not be viewable) is indicative of a user reading a message or taking a call, while changing the position of the cell phone to a higher location above the user's head, with camera tilted downward indicates video mode, the video mode being used as a parameter for identifying a fight. At 230, the velocity associated with cell phone movement from vertical tilted position to the tilted above the head position provides yet another measurable parameter for identifying a fight.

All of the measurable parameters associated with phone position and change in position can be used for comparison to a predetermined threshold indicative of fight incident. The processing and analytics may comprise techniques of image recognition such as but not limited to people recognition, object recognition, object tracking, and motion analysis to determine the detections of people, cell phones, cell phone owners, further determining their locations, movements, positional changes. These measurable parameters are beneficially based on cell phone positioning and aiming direction and thus negate any need for eye gaze analytics or facial recognition, as a cell phone owner's face and eyes may be blocked within the FOV.

The following Table summarizes measurable parameters that may be used to identify a fight incident and non-incident:

Measurable parameters for a detected gathering:

| | |
|---|---|
| Gathering person count: | xx |
| Velocity of gathering | Compare to stored gathering velocity threshold(s): |
| | Output: normal, growing, shrinking |
| Detected viewable phone count | yy |
| Detected viewable phone owners | zz |
| Ratio | yy/zz |
| detected phone count/viewable | |
| phone owners | |
| Change in phone position to an | YES or NO |
| overhead position | |
| If YES, measure velocity of | Compare velocity to predetermined velocity threshold(s): |
| change in phone position | Output: low, normal, high velocity |

Referring back to FIG. 1, and in accordance with some further embodiments, the processor 104 and analytics engine 106 may further be configured to verify the identified fight incident using aggregated results over time. The one or more aggregated results may be compared to previously stored aggregated results associated with previously confirmed fight incidents, the previously stored aggregated results being stored within the memory 108. An example of aggregated results will be described in conjunction with FIG. 4.

Referring back to FIG. 1, and in accordance with further embodiments, the processor 104 and analytics engine 106 may also be further configured to detect trends associated with the incident. The detected trends associated with the identified fight incident may then be compared to previously stored trends associated with previously confirmed fight incidents, the previously stored trends being stored within the memory 108.

The detection of trends in position and movement of the detected cell phones at the identified fight incident, may include one or more of: detecting, via the processor and analytics engine: trends in position and movement of the detected cell phones, trends in relative scale of movement of the detected cell phones entering and exiting the FOV of the security camera, trends in a ratio of number of cell phones present to number of viewable cell phone owners, trends in movement of the detected cell phones to an overhead position; and trends in velocity of the detected cell phones to the overhead position. The identified trends are then compared to known, previously stored trends associated with fight incidents.

The comparison of detected trends in position and movement to previously stored trends of previously confirmed fight incidents may further comprising determining, based on the comparison, that the identified fight incident aligns with at least one stored trend of the previously confirmed fight incidents. For example the detected trend matching or aligning with a previously stored trend would be indicative of a verification of the previously identified fight incident. The system may then supplement the alert with a verification notification of alignment with the at least one trend. The supplemented alert may also be communication to security devices, such as worn by security personnel and officer. For example, the previously stored trends, such as those described previously, may be based on confirmed fights at the current school and confirmed fights from other schools with similar hallway configuration and student body parameters, such as class size, similar schedules, and the like.

The processor 104 and analytics engine 106 may further determine, based on the comparison, that the identified fight incident aligns with at least one trend of the previously confirmed fight incidents. For example the detected trend matching or aligning with a previously stored trend would be indicative of an incident fight. The system may then supplement the alert with a verification notification of alignment with the at least one trend. The supplemented alert may also be communication to security devices, such as worn by security personnel and officer. For example, the previously stored trends, such as those described previously, may be based on confirmed fights at the current school and confirmed fights from other schools with similar hallway configuration and student body parameters, such as class size, similar schedules, and the like

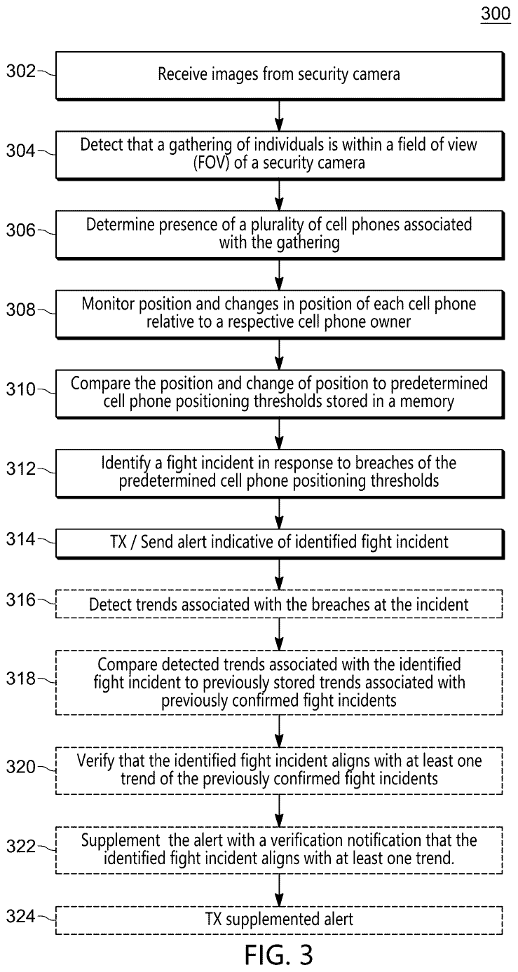

FIG. 3 is a flowchart of a method 300 for detecting a fight incident in accordance with some embodiments. The method 300 begins at 302 with receiving images from a security camera. For example the transceiver 111 receives a video signal from camera 102, and the processor 104 performs digital processing on the signal. The method continues at 304 with detecting a gathering of individuals within a field of view (FOV) of the security camera. The detection of the gathering may be accomplished processor 104 and analytics engine 106 processor 104 of FIG. 1 using, for example, detection based approach such as people counting systems, distance between people estimation systems and/or deep learning density estimation systems

In accordance with some embodiments, the method proceeds to 306 with determining a presence of a plurality of cell phones associated with the gathering, followed at 308 with monitoring position and changes in position of each cell phone relative to a respective cell phone owner, and then comparing, at 310, the position and change in position to predetermined cell phone positioning thresholds stored in a memory. For example, the memory 108 of FIG. 1 may store the predetermined cell phone positioning thresholds

The method 300 continues to 312 with identifying a fight incident in response to breaches of the predetermined cell phone positioning thresholds. For example, change in position from lower (below the face) handheld cell device to overhead cell device of a certain number of cell phone owners would be indicative of a fight. At 314, the method continues with sending an alert notification indicative of the identified fight incident. For example, the alert notification may be transmitted to a security radio, such as used by security personnel and/or a public safety radio such as used by public safety personnel. The alerts may be transmitted using a transmission frequency associated with the communication system, for example, LTE, LMR (VHF, 700/800, UHF), to name a few.

In some embodiments, the monitoring of 308 may include measuring, via the processing and analytics engine, parameters associated with the gathering of individuals and cell phones within the FOV of the security camera, as was described in FIGS and 2); and aggregating the measured parameters to verify the identified fight incident. The generated alert may be supplemented with a fight incident verification based on the aggregation. An example of aggregation is described in conjunction with FIG. 4.

In accordance with further embodiments, the method may further proceed to 312 with detecting trends associated with the breaches at the identified fight incident, and comparing, at 316, the detected trends associated with the breaches of the identified fight incident to previously stored trends associated with previously confirmed fight incidents, the confirmed trends being stored in the memory. The method continues to 318 with determining, based on the comparison at 318, that the identified fight incident aligns with at least one trend of the previously confirmed fight incidents. The method continues to 320 with supplementing the alert with a verification notification that the identified fight incident aligns with the at least one trend, and sending the supplemented alert to a security radio, such as used by security guards and/or public safety officers. For example, the supplemented alert signal may be transmitted from the transceiver of FIG. 1 over the system's operating frequency to security radios associated with the communication system 100. The trends may be analyzed with or with the use of aggregated results.

FIG. 4 provides an example workflow 400 for generation of aggregated results which can be used for additional verification of an identified fight incident in accordance with some embodiments The workflow 400 is described herein in terms of gathering with one group of individuals and cell phones within that one group, with the understanding that the workflow may be applied to one or more groups within the gathering The aggregation of analytical results may be based on parameters associated with individuals at a scene and cell phones associated with the scene. The workflow 400 is managed by the processor and analytics engine of FIG. 1.

In this example embodiment, the workflow 400 provides three analytical paths leading to three different aggregated results. In this example embodiment, the three aggregations comprise aggregation of number of cell phone detections 412, aggregation ratio of cell phone position versus owner head 414, and aggregation ratio of viewable cell phone owners and viewable cell phones.

At 402 parameter measurements are taken, as previously described, to detect a gathering of individuals, such as shown in FIG. 1. For example, the gathering may be detected within the FOV of the security camera 102 for a current scene on a per frame basis using bounding boxes, or other suitable counting technology. As another example, density based analysis may be used to calculate the density of individuals within a specific area, where a high density is indicative of a gathering As another example, blob detection may be used to identify clusters of pixels that represent individuals at a scene, where the clusters are counted to determine the size of a gathering. As yet another example, non-visual sensors may be used to detect a gathering. Examples of non-visual sensors may include for example, audio sensors upon which audio analytics are performed to recognize multiple distinct voices to detect a gathering, and halo sensors which detect movement and people counting based on CO2 readings.

In response to the detection of a gathering at 402, the workflow at 404 detects parameters including the number of individuals in the group and also detects the number of cell phones in the group at 406. These parameters (individuals at 404 and cell phones at 406) may be measured using computational algorithms, for example convolutional neural networks (CNN-1) which may be used to detect particular objects on the frames, and once detected count the occurrences. Other suitable machine learning networks may also be used, for example Haar Cascades, Histogram of Oriented Gradients, Support Vector Machine, Region-based Convolutional Neural Networks (R-CNNs), YOLO (You Only Look Once), Single Shot MultiBox Detector (SSD), Transformer based Models.

The detection of mobile phones within the group at 406 may be aggregated over time at 412, also using for example convolutional neural network technology (CNN-2) and/or other suitable machine learning algorithm, as described previously. The aggregated result of number of detections over time 412 are provided to an incident verification block at 420 (first path).

In accordance with the embodiments, visual analytics are performed at 408 to determine an association of individual cell phone to a person, also referred to as an owner, and based on position of the cell phone relative to that person. For example the association may be determined based on overlapping bounding boxes of detected person with detected cell phone bounding box. The association may also be determined using subsidiary analytics operating on a blob level (body parts of person previously detected), where a search for detected cell phone overlaps with selected blob(s) (i.e. hand, head). The determination of association at 408 may output a mapping of ownership indicating which cell phone is associated with which person. The mapping output may be in the form of a graph or a simple table associating objects from one set (cell phone) to another (person). While counts of viewable cell phone associated with viewable owners (unblocked views) and counts of viewable cellphones without viewable owners (e.g. blocked views) may be taken, the mapping is preferable as the mapping may be used as a basis to measure phone position versus head.

The associations determined at 408 proceed down two different aggregation paths (one path based on unblocked views) and another path based on blocked views At 410, a ratio of the viewable cell phone position relative to the viewable owner head (unblocked view) is calculated. For example, the determination of the ratio at 410 may include an average cell phone position calculated over all detected viewable cell phone owners with respect to particular person head position, where center of the head position indicates a reference point for the measurement for the corresponding cell phone position. The center of the head may be set as a “0”, and if the phone is below the head (zero point reference) the phone will be assigned a negative “−” sign value, and if the phone is above the head (zero point reference), the phone will be assigned a positive “+” sign value. Averaging over all measurements will generate a value in centimeters (cm). In another example, a coefficient may be generated at 410 defining an average value of the ratio of the position of the cell phone relative to a reference point (e.g. being the feet of a person) and the position of the centre of that person's head measured relative to the same reference point. The generated average ratio in this case is dimensionless.

The workflow 400 then proceeds to 414 for aggregation of measured ratios of the viewable cell phone position versus viewable owner head over time. The aggregated ratios of the cell phone position versus owner head over time 414 are forwarded to the incident verification block 420 of the analytics engine as a second path input.

The association of individual cell phone owner and position of the cell phone relative to that owner, as determined at 408, is also used as part of the third aggregation path. In this third path, a ratio of viewable cell phone owners with viewable cell phones versus viewable cell phones without viewable owners (i.e. unblocked views vs blocked views) is aggregated over time and forwarded to the incident verification block 420.

The different parameter aggregation results thus include aggregated number of cell phone detections over time 412, aggregated changes in ratio of cell phone position vs owner head over time 414 (unblocked views), and aggregated ratio of viewable cell phone owners with viewable cell phones versus viewable cell phones without viewable owners over time 416. The aggregated results 412, 414, and 416 measured over time are forwarded to the analytics engine of FIG. 1 for verification of the identified fight incident The incident verification may compare the aggregated results to individual thresholds stored for aggregated results stored in memory. The aggregated results may be used for incident verification on their own or in conjunction with the trend analysis described at FIG. 3.

Accordingly, there has been provided an improved method and system for detecting a fight. The embodiments leverage the position and change in position to identify a fight incident. The velocity of the change of phone direction and orientation may also be correlated across multiple phones to provide improved identification of a fight incident. Identifying trends and performing trend verification based on timing of movements may also be considered in verifying the fight incident. Hence, even a single security camera having a blocked view of an incident can now identify a fight incident. The system and method further allow for the determination of aggregated results and/or trends for verification of an identified incident. The system advantageously does not rely on the use of eye gaze analytics, and does not require multiple cameras. The system and method are particular advantageous to hallway applications, where the hallway is associated with a predictive human traffic flow, such as a school hallway where students change classrooms based on a predetermined classroom schedule

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot monitor position and changes in position of cell phones within a gathering; compare position and change of position to predetermined cell phone positioning thresholds, and cannot identify a fight incident in response to breaches of the predetermined cell phone positioning thresholds, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors.

Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of detecting a fight, comprising:
detecting, via a processing and analytics engine associated with a security camera of a communication system, that a gathering of individuals is within a field of view (FOV) of the security camera;
determining a presence of a plurality of cell phones associated with the gathering of individuals;
monitoring position and changes in position of each cell phone of the plurality of cell phones associated with the gathering relative to a respective cell phone owner;
comparing the position and change of position to predetermined cell phone positioning thresholds stored in a memory associated with the processing and analytics engine;
identifying a fight incident in response to breaches of the predetermined cell phone positioning thresholds; and.
generating and sending an alert indicative of the fight incident to a security radio associated with the communication system.

2. The method of claim 1, wherein monitoring further comprises:
measuring, via the processing and analytics engine, parameters associated with the gathering of individuals and cell phones within the FOV of the security camera; and
aggregating the measured parameters to verify the identified fight incident.

3. The method of claim 1, wherein the method of detecting a fight is applied to a building having a hallway, the hallway being associated with a predictive human traffic flow monitored by the security camera.

4. The method of claim 3, wherein the hallway is a school hallway where students change classrooms based on a predetermined classroom schedule.

5. The method of claim 1, wherein—the fight incident occurs under at least one of:
the fight incident occurs outside the FOV of the security camera, while the gathering of individuals are within, or at least partially within, the FOV of the security camera; and
the fight incident occurs within the FOV of the security camera, the fight incident being obstructed by the gathering of individuals within the FOV of the security camera.

6. The method of claim 1, wherein determining the presence of the plurality of cell phones associated with the gathering of individuals, further comprises analyzing via the analytics engine, parameters associated with the plurality of cell phones, comprising:
determining a total number of individuals at the gathering within the FOV of the security camera;
determining a total number of individuals at the gathering holding a cell phone within the FOV of the security camera;
determining a percentage of cell phone owners at the gathering, based on number of cell phone owners and total number of individuals at the gathering within the FOV of the security camera;
comparing the percentage of cell phone owners to a predetermined cell phone owner threshold stored in the memory; and
in response to the percentage of cell phone users exceeding the cell phone owner threshold, then monitoring the position and changes in position of each cell phone relative to a respective cell phone owner.

7. The method of claim 1, wherein monitoring position and changes in position of each cell phone relative to the respective cell phone owner, comprises:
determining position and change in position of each cell phone over time within the FOV of the security camera; and
determining position and change in position of each cell phone relative to a cell phone owner's head within the FOV of the security camera.

8. The method of claim 1, further comprising:
providing verification to the identified fight incident based on trends.

9. The method of claim 8, wherein providing the verification to the identified fight incident based on trends comprises:
detecting, via the processing and analytics engine, trends in position and movement of the cell phones at the identified fight incident, and
comparing the detected trends in position and movement to previously stored trends of previously confirmed fight incidents stored in the memory.

10. The method of claim 9, wherein providing the verification to the identified fight incident further comprises:
detecting trends associated with the breaches at the identified fight incident;
comparing the detected trends associated with the breaches to previously stored trends associated with previously confirmed fight incidents stored in the memory;
determining, based on the comparison, that the identified fight incident aligns with at least one stored trend of the previously confirmed fight incidents; and
supplementing the alert with a verification notification indicating alignment of the identified fight incident with the at least one stored trend.

11. The method of claim 9, wherein detecting trends in position and movement of the cell phones, comprises:
determining, via the processing and analytics engine, trends in relative scale of movement of the cell phones entering and exiting the FOV;
determining, via the processing and analytics engine, trends in a ratio of number of cell phones present to number of viewable cell phone owners within the FOV
determining, via the processing and analytics engine, trends in movement of the detected cell phones to an overhead position; and
determining, via the processing and analytics engine, trends in velocity of the detected cell phones to the overhead position.

12. The method of claim 1, wherein monitoring the method is performed without use of eye gaze analytics.

13. A communication system, comprising:
a security camera;
a processor operatively coupled to the security camera;
an analytics engine operatively coupled to the processor;
a memory operatively coupled to the processor and analytics engine,
the processor and analytics engine being configured to:
receive image inputs from the security camera;
detect, within the received image inputs, a gathering of individuals within a field of view (FOV) of the security camera;
determine a presence of a plurality of cell phones associated with the gathering of individuals;
monitor position and changes in position of each cell phone relative to a respective cell phone owner;
compare the position and change of position to predetermined cell phone positioning thresholds stored in a memory associated with the processing and analytics engine;
identify a fight incident in response to breaches of the predetermined cell phone positioning thresholds; and.
generate and send an alert indicative of the fight incident to a security radio associated with the communication system.

14. The communication system of claim 13, wherein monitoring further comprises:
measuring, via the processor and analytics engine, parameters associated with the gathering of individuals and cell phones within the FOV of the security camera; and
aggregating the measured parameters to identify the fight incident.

15. The communication system of claim 13, wherein—the identified fight incident occurs under at least one of:
the fight incident occurring outside the FOV of the security camera, while the gathering of individuals are within, or at least partially within, the FOV of the security camera; and
the fight incident occurring within the FOV of the security camera, wherein the fight incident is obstructed by the gathering of individuals within the FOV of the security camera.

16. The communication system of claim 13, wherein the processor and analytics engine are further configured to:
provide verification to the identified fight incident.

17. The communication system of claim 16, wherein the verification to the identified fight incident is based on:
a detection of trends in position and movement of the cell phones at the identified fight incident by the processor and analytics engine;
a comparison of the detected trends in position and movement to previously stored trends of previously confirmed fight incidents stored in the memory; and
alignment of at least one of the detected trends with at least one stored trend of the previously confirmed fight incidents.

18. The communication system of claim 16, wherein the verification to the identified fight incident further comprises the processor and analytics engine being configured to:
detect trends associated with the breaches at the incident;
compare the detected trends associated with the breaches to previously stored trends associated with previously confirmed fight incidents stored in the memory;
determine, based on the comparison, that the identified fight incident aligns with at least one stored trend of the previously confirmed fight incidents; and
supplement the alert with a verification notification indicating alignment of the identified fight incident with the at least one stored trend.

19. The communication system of claim 13, wherein the position and changes in position of each cell phone relative to the respective cell phone owner is performed without eye gaze analytics.
